(19) United States
(12) Patent Application Publication
(10) Pub. No.: US 2007/0024886 A1
(43) Pub. Date: Feb. 1, 2007

(54) Image processing device

(75) Inventors: Yuji Okamoto, Souraku-gun (JP); Shuhji Fujii, Souraku-gun (JP); Toshihiro Yamanaka, Ikoma-shi (JP); Syouichirou Yoshiura, Ikoma-gun (JP)

Correspondence Address: EDWARDS & ANGELL, LLP, P.O. BOX 55874, BOSTON, MA, 02205, US

(73) Assignee: Sharp Kabushiki Kaisha, Abeno-ku (JP)

(21) Appl. No.: 10/570,970

(22) PCT Filed: Sep. 8, 2004
(86) PCT No.: PCT/JP04/13073

§ 371 Date: Mar. 8, 2006

(30) Foreign Application Priority Data
Sep. 9, 2003 (JP) 2003-317563

(51) Int. Cl. G06K 15/00; G06F 15/00

(52) U.S. Cl. 358/1.14; 358/1.9; 358/448

(57) ABSTRACT

An image processing device determines, based on an IP address received from an external device, whether any processing according to information received from the external device should be performed or not. A path of communication with the external device is examined from a network address. When the external device that is a transmission source of information is an external device outside a predetermined range, specifically, for example, when the external device is an external device connected to a communication network that is further external to the communication network connected to the image processing device, the image processing device inhibits any processing that follows an image data processing command received from the external device. The image processing device also inhibits any processing that follows a command of adjusting the image processing device which command is received from outside the predetermined range.

### CROSS-REFERRENCE TO RELATED APPLICATION

This application is the national phase under 35 U.S.C. § 371 of PCT International Application No. PCT/JP 04/013073 which has an International filing date of Sep. 8, 2004 and designated the United States of America.

### BACKGROUND OF THE INVENTION

1. Field of the Invention

The present invention relates to an image processing device which can protect image data from unauthorized use.

2. Description of the Related Art

Recently an image processing device having a copying function, in which an image recorded on a sheet is scanned to capture as an image data and the image is formed and outputted based on the captured image data, has become multifunctional. In addition to a copying function, the image processing device having plural functions such as a network printer which receives the image data from an external device such as a personal computer (PC) to output the image while connected to a communication network such as LAN, a facsimile function in which the image data is transmitted and received with an external facsimile device by facsimile communication, and a transmission function of transmitting the captured image data to the external device is put to practical use. In order to perform image data processing in each function without stagnation, while the multifunctional image processing device has storing means, such as a hard disk drive, in which information such as the image data is stored to sequentially store the accepted information, the multifunctional image processing device is provided with a concurrent processing function of sequentially processing the information already stored in the storing means.

There is also realized an image processing device in which the function of the storing means incorporated in the above image processing device is enhanced, specifically the image processing device which can be used as an image data server device. In the image data server device, the image data is stored in storing means and the stored image data can be outputted as necessary. For example, Japanese Paten Application Laid-Open No. 6-178041 (1994) discloses an image data output control device having an electronic filing function in which the image data captured with use of a scanner or the image data received by the facsimile communication is stored and a command is issued as necessary such that the image data is read to output the image. In the case where the image processing device above described is used, the image data utilized once can be re-used by recording a recording sheet as the image or by transmitting the image data to the external device, so that a user can easily use the image data such as a fixed form as necessary.

Japanese Patent Application Laid-Open No. 7-200200 (1995) and Japanese Patent Application Laid-Open No. 8-18723 (1996) disclose a remote processing technology configured such that various processing commands are transmitted from the external device connected to the image processing device through the communication network and the image processing device performs the processing following the received command. In such prior arts, for example, the operation in which the image data stored in the image processing device is taken out by an access from the external device, the operation in which the function of the image processing device is set from the external device, and the like can be performed by the remote processing. Therefore, it is not necessary for the user to go to the image processing device to directly operate the image processing device, and facility of the image processing device connected to the communication network is improved.

Japanese Patent Application Laid-Open No. 2002-57721 discloses a technology in which maintenance of the image processing device such as check and function adjustment is remotely performed through the communication network such as the Internet further outside the communication network connected to the image processing device. A management company which manages the image processing device can grasp the status of the image processing device to maintain the image processing device by using the conventional technology, even if an operator does not go to an installation place of the image processing device. Therefore, the management of the image processing device is simplified.

On the other hand, sometimes the image data having confidentiality such as a document in which company secret is described is included in the image data dealt with by the image processing device. Accordingly, when the unrestraint access can be obtained from the outside in the image processing device, security problems such as information leakage, unauthorized use of information, and unauthorized access are generated. Therefore, Japanese Patent Application Laid-Open No. 7-28365 (1995) discloses a copying device in which personal identification is performed before use to permit only the previously registered user to use the copying machine. Japanese Patent Application Laid-Open No. 2000-187491 discloses a copying machine in which particular information can be buried in the outputted image to pursuit a leakage route in the case where the outputted image leaks to the outside.

However, in the conventional image processing device, currently adequate security is not established against the access from the outside through the communication network. In the case where the unauthorized access is performed to the image processing device from the outside to transmit the image data including the confidentiality through the external communication network, the image data including the confidentiality leaks extensively. In the case where unauthorized maintenance processing is remotely performed from the outside, for example, the setting is changed such that the image data is transmitted to the outside, which generates a risk that the confidential information such as the image data and usage of the device leaks out. Degrees of a range and a speed in the case where the information leaks through communication network become much larger compared with the case where the image outputted by recording the information in the sheet leaks out, the countermeasure against the unauthorized use through the communication network is required rather than the countermeasure against the unauthorized use of the outputted image.

### BRIEF SUMMARY OF THE INVENTION

In view of the foregoing, an object of the present invention to provide an image processing device which can protect information of a processing target by restricting an access from the outside, particularly by restricting the access out of the range of a predetermined communication network such as LAN.

An image processing device according to the present invention is an image processing device comprising: receiving means for receiving information from an external device; and means for performing processing of an image data according to the received information, and is characterized by comprising: protecting means capable of switching a state thereof between a state in which operation for protecting the image data can be performed and a state in which said operation cannot be performed; and restricting means for restricting said processing when said protecting means is in the state in which said operation can be performed.

An image processing device according to the present invention is an image processing device comprising: receiving means for receiving information from an external device; and means for performing processing of an image data according to the received information, and is characterized by comprising: means for detachably mounting protecting means which can, when mounted, perform an operation for protecting the image data; and restricting means for restricting said processing when said operation of said protecting means can be performed.

In the image processing device of the present invention which processes the image data according to the information received from the external device, in the case where the protecting means for encrypting the image data to protect the image data from taking out the image data outside the image processing device to illegally use the image data can be operated, the processing according to the information received from the external device is restricted. In the case where the protecting means is the protecting means which is switched between the state in which the operation can be performed and the state in which the operation cannot be performed by the setting, the operation can be performed. In the case where the protecting means is the detachable protecting means, the operation can be performed when the protecting means is mounted.

An image processing device according to the present invention is characterized in that said receiving means comprises: means for receiving path information indicating communication path of said external device from said external device; and means for receiving a processing command of the image data from the external device, and said restricting means comprises: means for determining whether said communication path falls within a predetermined path range or not based on the path information received by said receiving means; means for permitting a processing following said processing command when said communication path falls within the predetermined path range; and means for prohibiting a processing following said processing command when said communication path does not fall within the predetermined path range.

Further, in the image processing device of the present invention, the processing command of the image data from the external device, and the path information indicating the communication path between the external device and the image processing device are received from the external device. In the case where the communication path falls within the predetermined path range such as LAN connected to the image processing device, the image data is processed following the received processing command. In the case where the communication path does not fall within the predetermined path range such that the information is transmitted from the communication network outside LAN, the performance of the processing following the received processing command is prohibited.

An image processing device according to the present invention is characterized by further comprising means for performing a processing for maintenance according to the information received from the external device, wherein said receiving means comprises: means for receiving the path information indicating the communication path of said external device from the external device; and means for receiving a maintenance command instructing said processing from the external device, and said restricting means comprises: means for determining whether said communication path falls within the predetermined path range or not based on the path information received by said receiving means; and means for prohibiting said processing when said communication path does not fall within the predetermined path range.

Further, in the image processing device of the present invention, the maintenance command instructing the processing of maintaining the image processing device such as the checkout and the setting change is received from the external device, and the path information is also received. In the case where the communication path does not fall within the predetermined path range, the performance of the processing following the received maintenance command is prohibited.

An image processing device according to the present invention is characterized in that said receiving means further comprises means for receiving identification information identifying the external device, storing means is provided, said storing means storing the identification information of the external device previously determined as a source external device of the maintenance command, while the maintenance command received from the external device are classified by contents of the maintenance command capable of performing processing, and said restricting means comprises: means for determining whether the identification information received by said receiving means coincides with any of the identification information stored in said storing means, when said communication path falls within the predetermined path range; means for prohibiting a processing following the maintenance command received by said receiving means, when the identification information does not coincide; means for determining whether the identification information is classified so as to be capable of performing a processing following the contents of the maintenance command received by said receiving means or not, when the identification information coincides; means for permitting said processing, when the identification information is classified so as to be capable of performing said processing; and means for prohibiting said processing, when the identification information is not classified so as to be capable of performing said processing.

Moreover, in the image processing device of the present invention, the identification information of the external device is stored while classified with respect to the contents of the processable maintenance command, and the identification information is received from the external device. In the case where the source external device of the maintenance command is classified in the external device in which the contents of the maintenance command can be processed, the processing following the maintenance command is performed. In the case where the source external device of the maintenance command is not classified in the external device in which the contents of the maintenance command can be processed, the performance of the processing following the maintenance command is prohibited.

In the image processing device of the present invention which processes the image data according to the information received from the external device, in the case where the protecting means for protecting the image data from the unauthorized use can be operated, the processing according to the information received from the external device is restricted. Accordingly, since the unrestraint utilization of the image data from the external device is prohibited, the information security of the image processing device is improved.

Further, in the image processing device of the present invention, in the case where the communication path of the external device does not fall within the predetermined path range, the performance of the processing following the processing command of the image data received from the external device is prohibited. Accordingly, obtaining the access to the image processing device from the outside of the range of the limited communication network such as intra-firm LAN to taken out the image data is prevented. Therefore, the image data can be protected against the unauthorized use, so that the information security of the image processing device can be improved.

Further, in the image processing device of the present invention, in the case where the communication path of the external device does not fall within the predetermined path range, the performance of the processing following the maintenance command received from the external device. Therefore, that the image processing device cannot protect the image data against the unauthorized use by illegally controlling the state of the image processing device such that the setting of the image processing device is changed to be able to transmit the information to the outside of the predetermined communication network is prevented. Accordingly, the information security of the image processing device can further be improved.

Moreover, in the image processing device of the present invention, in the case where the source external device of the maintenance command is classified in the external device in which the processing following the contents of the maintenance command can be performed, the processing following the received maintenance command is performed. Therefore, the external device which can transmit the maintenance command to perform the image processing device maintenance processing is limited to the external device such as an administrator's PC. Accordingly, the present invention has excellent advantages that the unauthorized control of the image processing device becomes more difficult and the information security of the image processing device 1 is improved.

### BRIEF DESCRIPTION OF THE SEVERAL VIEWS OF THE DRAWINGS

FIG. 1 is a block diagram showing a functional configuration of an inside of an image processing device according to the present invention;

FIG. 2 is a schematic view showing an image data processing performed by the image processing device while a security program can be operated;

FIG. 3 is a conceptual diagram showing an example of contents of registered information stored in a management part;

FIG. 4 is a flowchart showing a processing procedure performed by the image processing device of the present invention which receives information from an external device; and

FIG. 5 is a flowchart showing a processing procedure performed by the image processing device of the present invention which receives information from the external device.

The above and further objects and features of the invention will more fully be apparent from the following detailed description with accompanying drawings.

### DETAILED DESCRIPTION OF THE PRESENT INVENTION

Preferred embodiments of the present invention will specifically be described below with reference to the accompanying drawings.

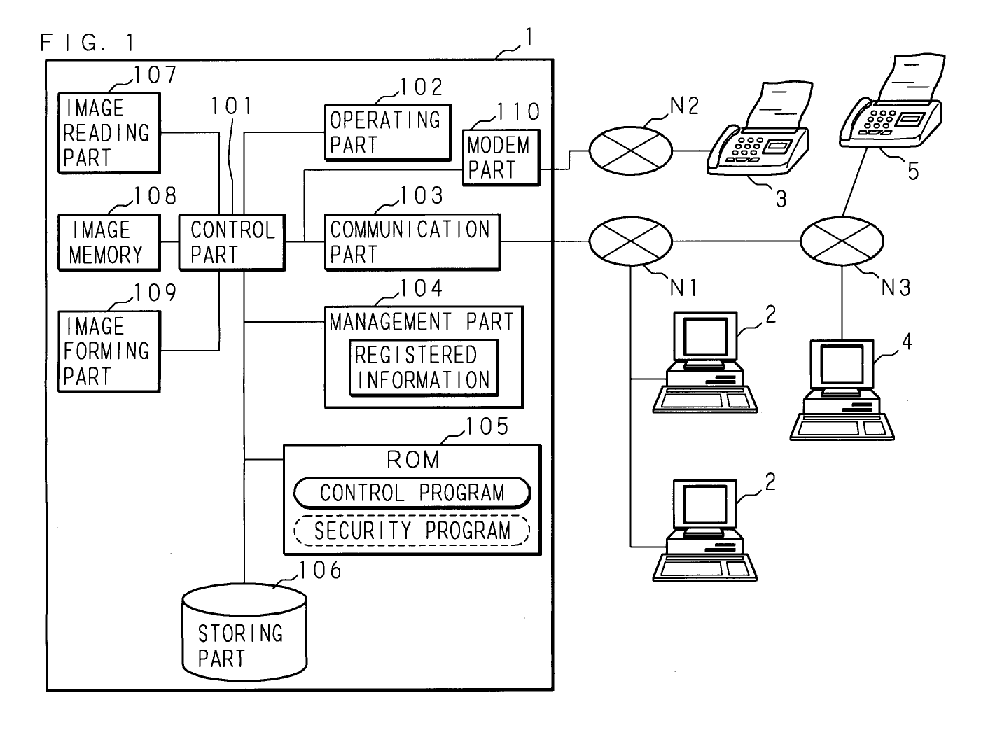

FIG. 1 is a block diagram showing a functional configuration of an inside of an image processing device according to the present invention. The image processing device 1 is provided with a control part 101 including a CPU which performs operation and a RAM in which information is temporarily stored in association with the operation. To the control part 101, a ROM 105 which stores a control program for controlling the image processing device 1 is connected. The control part 101 controls the whole of the image processing device 1 according to the control program stored in the ROM 105. Further, to the control part 101, a management part 104 which is of a memory and stores management information for managing the processing performed by the image processing device 1 is connected. The control part 101 refers to the management information stored in the management part 104, and the control part 101 controls the image processing device 1 based on the information referred to. To the control part 101, an image reading part 107 which scans and reads the image recorded on the sheet, and generates electronic image data based on the read data, an image memory 108 which temporarily stores the image data, and an image forming part 109 which forms the image from the image data, and prints the formed image on the recording sheet to output the recording sheet are connected. The image processing device 1 functions as a copying device which makes a copy of the read image. That is, in the image processing device 1, the image reading part 107 reads the image to generate the image data, the generated image data is stored in the image memory 108, the image forming part 109 forms the image from the stored image data and outputs the image. To the control part 101, a storing part 106 which is composed of a hard disk drive or a non-volatile memory is connected. The storing part 106 stores image data processed by the image processing device 1. To the control part 101, an operating part 102 which accepts an operation from a user is connected. The operating part 102 is composed of displaying means such as a liquid crystal panel which displays the information necessary to the operation, and inputting means such as a touch panel and a numeric keyboard to which information such as a control command is inputted by the user's operation.

To the control part 101, a communication part (receiving means) 103 connected to a communication network N1 such as LAN is connected. The communication part 103 exchanges information with external devices through the communication network N1. To the communication network N1, plural personal computers (PC) 2, 2, . . . are connected. The communication part 103 receives the image data transmitted from PC 2 through the communication network N1, and the image forming part 109 can form the image from the image data received by the communication part 103 and output the image, so that the image processing device 1 functions as a network printer. The image reading part 107 reads the image to generate the image data, and the image data can be transmitted from the communication part 103 to PC 2 through the communication network N1, so that the image processing device 1 functions as a network scanner.

The communication network Ni is connected to an external wide-area communication network N3 such as the Internet. The image processing device 1 has the function of an Internet facsimile which transmits the image data to another facsimile device 5, connected to the wide area communication network N3, through the communication network N1 and the wide-area communication network N3. The image processing device 1 can accept an access from a predetermined information processing device 4 connected to the wide-area communication network N3. When the image processing device 1 accepts the access from the information processing device 4 of a management company which manages the image processing device 1, the image processing device 1 receives a maintenance command from the information processing device 4. According to the received maintenance command, the image processing device 1 transmits the information indicating the state of the image processing device 1 such as presence or absence of failure and frequencies of consumable supplies, the image processing device 1 changes setting, and the image processing device 1 performs a maintenance processing.

To the control part 101, a modem part 110 which performs facsimile communication is connected, and the modem part 110 is connected to a public switched telephone network N2. The image processing device 1 can transmit the image data, generated by reading the image with use of the image reading part 107, to another facsimile device 3 through the public switched telephone network N2 connected to the modem part 110 by the facsimile communication. The image processing device 1 can receive by the modem part 110 the image data transmitted from the facsimile device 3 by the facsimile communication, through the public switched telephone network N2, and the image forming part 109 can form the image from the image data to output the image.

The storing part 106 stores the image data used in the image output, the copy, the image data transmission, and the facsimile transmission and reception. When a processing command for the image data is accepted by the user's operation of the operating part 102, the image processing device 1 displays a list of the image data stored in the storing part 106 on the displaying means of the operating part 102. Then, the image processing device 1 accepts selection of the image data to be used, and the image processing device 1 forms the image from the image data, the image processing device 1 transmits the image data to PC 2, or the image processing device 1 performs the facsimile transmission of the image data. Similarly the image processing device 1 can use the image data stored in storing part 106, by accepting a command for using an image data from PC 2 through the communication network N1. Thus, the image processing device 1 functions as an image data server, because the image processing device 1 can use the image data stored in the storing part 106.

The above-described various functions of the image processing device 1 are controlled by the control part 101 according to the control program stored in the ROM 105. In addition to the control program, the image processing device 1 of the present invention is configured such that the control part 101 performs the control by following a security program for improving the security. The control part 101 is operated as the protecting means of the present invention according to the security program stored in the ROM 105. When ROMs are exchanged to mount the ROM 105 in which the security program is stored, the security program can be operated, and the protecting means of the present invention can be operated. Alternatively, the ROM 105 is configured to be able to switch the stored security program between an operable state and an inoperable state, the operating part 102 accepts a command for operating a security program to switch the security program to the operable state, and thereby the protecting means of the present invention can be operated. In the case where the control part 101 is operated as the protecting means of the present invention according to the security program stored in the ROM 105, the image data stored in the storing part 106 can be protected from the unauthorized use of the image data, taken out outside the image processing device 1, by encrypting the image data. The control part 110 can if necessary protect the image data by performing processing such as to erase the image data, to overwrite the image data with another data, or to erase the image data stored in the storing part 106 when the image processing device 1 is started up. Sometimes the image data can be restored because of magnetization remaining in the storing part 106, even if the image data is erased from the storing part 106. Therefore, in erasing the image data, it is also possible to perform the setting such that the plural-time erasure is performed by the predetermined-time overwriting of the storing part 106 with random data.

In the case where the security program is not operated, the management part 104 stores management information for indicating a state in which the security program is not operated. In the case where the ROM 105 in which the security program is stored is mounted, or in the case where the security program stored in the ROM 105 can be operated, the control part 101 stores the management information for indicating a state in which the security program is operated in the management part 104. In the image data processing, the control part 101 checks the management information stored in the management part 104, and the control part 101 determines whether the contents of the management information are in the state in which the security program is operated or not. When the state in which the security program is operated, the control part 101 performs the processing while protecting the image data.

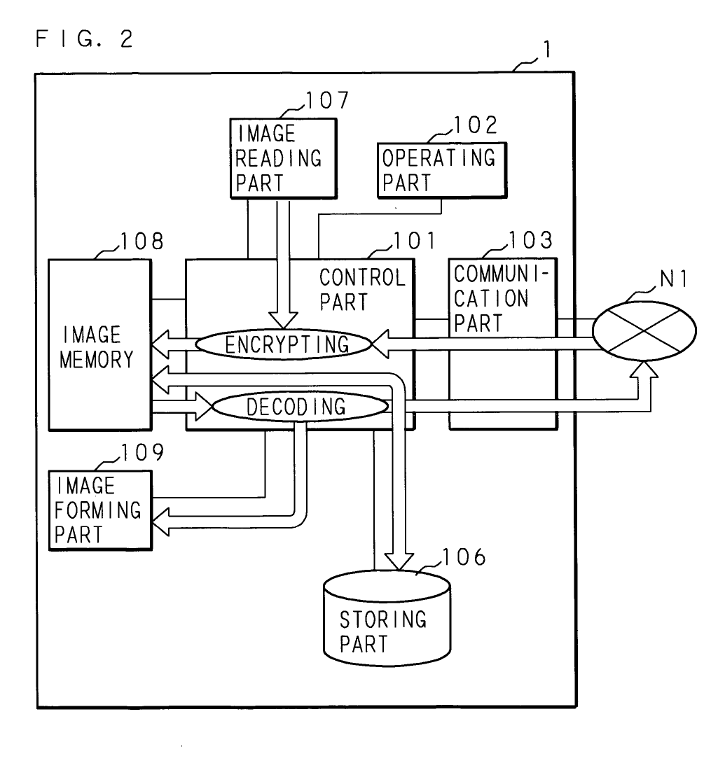

FIG. 2 is a schematic view showing processing of the image data performed by the image processing device 1 while the security program can be operated. In the case where the image processing device 1 processes the image data following the command from the external PC 2, the communication part 103 receives the image data and the command for processing from PC 2 through the communication network N1. In FIG. 2, a flow of the image data is shown by thick arrows. In processing the image data generated by the image reading part 107, the control part 101 accepts the image data from the image reading part 107 and accepts the processing command from the operating part 102. According to the control program and security program stored in the ROM 105, the control part 101 sequentially encrypts the accepted image data, stores the encrypted image data in the image memory 108 by page unit, and stores the encrypted image data stored in the image memory 108 in the storing part 106. According to the control program and security program stored in the ROM 105, the control part 101 reads the encrypted image data stored in the storing part 106 on to the image memory 108, and decodes the read image data. In the case where the image is outputted, the control part 101 transfers the decoded image data to the image forming part 109. The image forming part 109 forms the image from the image data and outputs the formed image. In the case where the image data is transmitted to PC 2, the control part 101 transmits the decoded image data from the communication part 103 to PC 2 through the communication network N1.

Moreover, in the present invention, in the case where the control part 101 controls the image processing device 1 according to the security program, according to the control program and security program, the control part 101 restricts the processing corresponding to the information received from the information processing device 4 connected to the wide-area communication network N3 or the information received from PC 2 connected to the communication network N1. The management part 104 stores the registered information that indicates a source external device of the received command by which, when the management part 104 receives the command for processing image data or the command of adjustment from PC 2 or the information processing device 4 as the external device, the processing should be performed. The control part 101 functions as the restricting means of the present invention according to the control program and security program to prohibit the processing following the command received from the external devices except for the predetermined external device registered in the registered information.

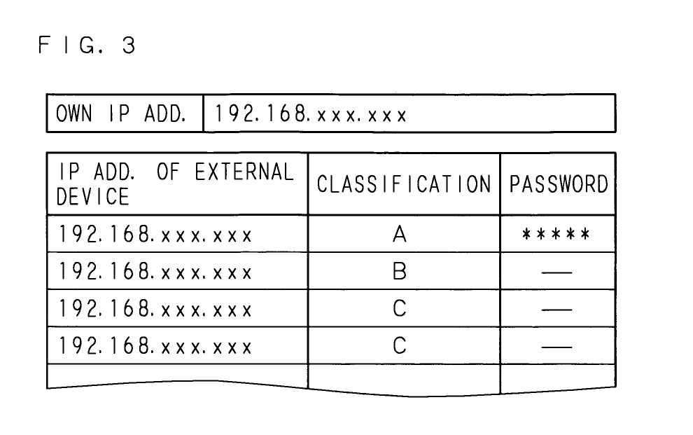

FIG. 3 is a conceptual diagram showing an example of contents of the registered information stored in the management part 106. An IP address of the image processing device 1 of itself is recorded in the registered information. Because the IP address includes a network address of the communication network N1 connected to the image processing device 1, it is possible to determine whether the external device is connected to the communication network N1 or to another communication network outside the communication network N1 by checking the network address of the IP address received from the external device. The IP addresses which are of identification information according to the present invention of each of PCs 2, 2, . . . connected to the communication network N1 are also registered in registered information. Further, classification information is recorded in association with the IP address corresponding to PC 2. The classification information classifies the source PCs 2, 2, . . . of the maintenance command according to the processable contents in all the contents of the maintenance command with respect to the image processing device 1. In the example shown in FIG. 2, the source PC 2, from which the image processing device 1 can accept and process all the contents of the maintenance command, such as a transmission direction of the information indicating the state of the image processing device 1 and a change command of setting of the image processing device 1, is classified into A. The source PC 2, from which the image processing device 1 cannot process the change command of the setting of the image processing device 1 in the contents of the maintenance command but can process the transmission direction of the information indicating the state, is classified into B. The source PC 2, from which the image processing device 1 cannot process all the contents of the maintenance command, is classified into C. For the source PC 2 classified into A, i.e., the source PC 2 from which the image processing device 1 can process all the contents of the maintenance command, a password for authentication is recorded in association with the IP address corresponding to the PC 2. The management part 104 functions as the storing means of the present invention by storing the above-described registered information therein.

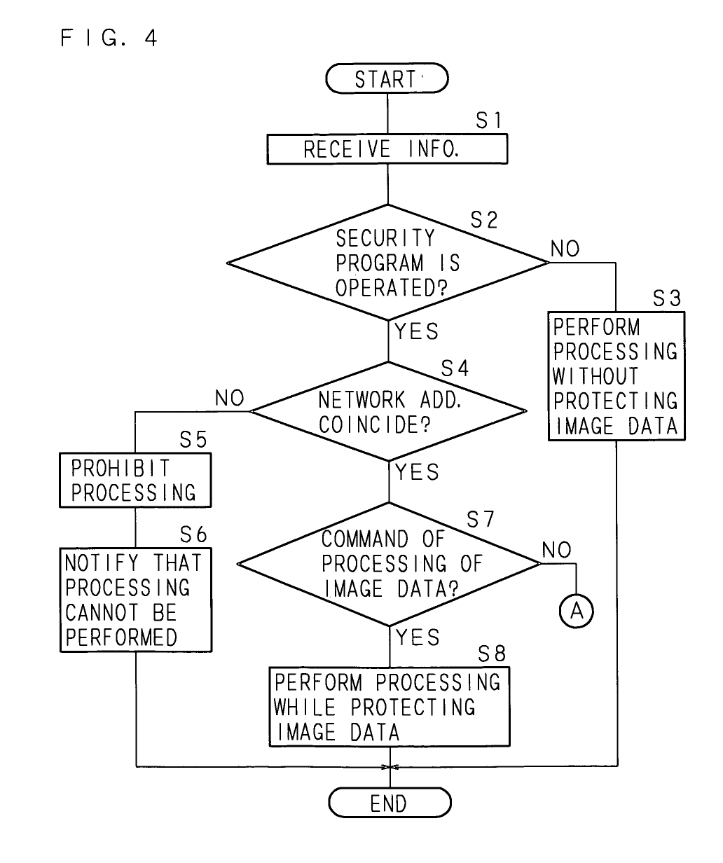

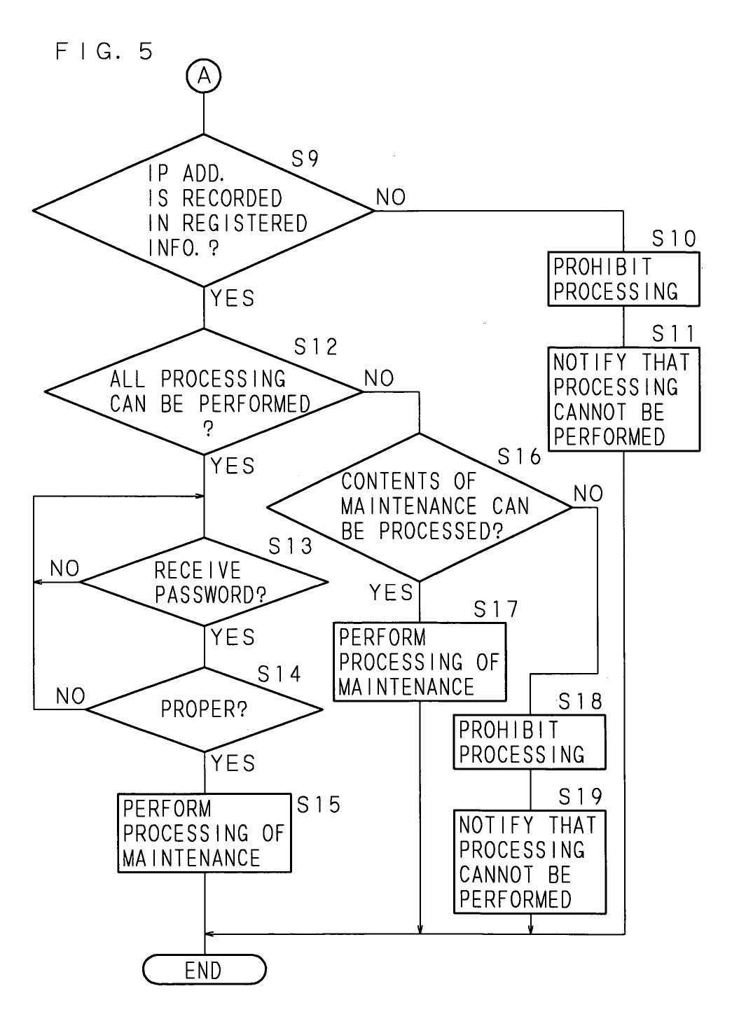

The operation of the image processing device 1 of the present invention will be described below with reference to a flowchart. FIG. 4 and FIG. 5 are a flowchart showing a procedure performed by the control part 101 when the image processing device 1 of the present invention receives the information from the external device. In the image processing device 1, the communication part 103 receives the information such as the processing command for the image data including the command that the image data transmitted from the external device is outputted as the image, the command that the image data stored in the storing part 106 is outputted to the external device, and the like, and the maintenance command of the image processing device 1 from the external device through the communication network N1 (S1). At this time, the image processing device 1 receives the information including the IP address of the external device. Then, the control part 101 of the image processing device 1 determines whether the contents of the management information indicate that the security program is operating condition or not by checking the management information stored in the management part 104 (S2). When the contents of the management information do not indicate that the security program is operating condition (NO in S2), the control part 101 performs the image data processing or the processing maintaining the image processing device 1 while the extra processing of protecting the image data is not performed (S3), and the process is ended.

When the contents of the management information indicate that the security program is operating condition (YES in S2), according to the control program and security program stored in the ROM 105, the control part 101 determines whether the network address included in the received IP address coincides with the network address included in the IP address of the image processing device 1, which is recorded in the registered information stored in the management part 104 (S4). When the network address of the external device does not coincide with the network address of the image processing device 1, it is found that the external device is connected to the communication network different from the communication network N1 connected to the image processing device 1, namely, it is found that the information received by the image processing device 1 is one which is received through the wide-area communication network N3 further outside the communication network N1. Accordingly, the control part 101 can determine whether the communication path of the information received from the external device falls within a predetermined path range of the communication network N1 or not by utilizing the IP address received from the external device as the path information according to the present invention. Alternatively, the communication path determination processing may be performed by recording one or plural network addresses in the registered information to compare the network address of the external device to the recorded network address.

In Step S4, when the network addresses do not coincide with each other (NO in S4), the received information is one which is transmitted from the external device connected to the wide-area communication network N3 outside the communication network N1. In this case, according to the control program and security program stored in the ROM 105, the control part 101 prohibits the processing according to the received information (S5). Then, the control part 101 notifies the source external device of the received information that the processing cannot be performed by transmitting the information indicating prohibition of the processing to the source external device of the received information (S6), and the process is ended.

In Step S4, when the network addresses coincide with each other (YES in S4), the received information is one which is transmitted from PC 2 connected to the communication network N1. In this case, the control part 101 determines whether the received information is a processing command of the image data or not according to the control program and security program stored in the ROM 105 (S7). When the received information is the processing command of the image data such as a command for outputting the image data transmitted from PC 2 in the form of the image or a command for transmitting the image data stored in storing part 106 to PC 2 (YES in S7), as described with reference to FIG. 2, the control part 101 performs the processing of the image data such as the output of the image while protecting the image data according to the control program and security program stored in the ROM 105 (S8), and the process is ended.

When the received information is the processing command of the image data (NO in S7), the received information is a maintenance command of the image processing device 1. In this case, the control part 101 determines whether the IP address received from PC 2 is included in the plural IP addresses recorded in the registered information stored in the management part 104 or not according to the control program and security program stored in the ROM 105 (S9). When the received IP address is not included in the registered information (NO in S9), according to the control program and security program stored in the ROM 105, the control part 101 prohibits the processing according to the received information (S1). Then, the control part 101 notifies the source external device of the received information that the processing cannot be performed by transmitting the information indicating prohibition of the processing to the source external device of the received information (S1 1), and the process is ended.

In Step S9, when the received IP address is recorded in the registered information (YES in S9), the control part 101 determines whether the received IP address is the IP address of PC 2 of the classification A, in which all the contents of the maintenance command can be processed, in the registered information or not according to the control program and security program stored in the ROM 105 (S12). When the received IP address is the IP address of the classification A in which all the contents of the maintenance command can be processed (YES in S12), according to the control program and security program stored in the ROM 105, after the control part 101 transmits a request of password from the communication part 103 to PC 2, the control part 101 monitors the reception of the password from PC 2 (S13). When the password is not received (NO in S13), the control part 101 continues the monitoring of the password. When the password is received (YES in S13), according to the control program and security program stored in the ROM 105, the control part 101 determines whether the password is proper or not by comparing the received password to the password stored in the registered information in association with the IP address (S14). When the password is improper (NO in S14), the control part 101 returns the processing to Step S13 to require the password again. When the password is proper (YES in S14), according to the control program and security program stored in the ROM 105, the control part 101 performs the maintenance processing of the image processing device 1 following the received maintenance command of the image processing device 1 such as a command changing the setting of the image processing device 1 (Sl5), and the process is ended.

In Step S12, when the received IP address is not the IP address of the classification A in which all the contents of the maintenance command can be processed (NO in S12), the control part 101 determines whether the received IP address is the IP address of the classification, in which the maintenance processing can be performed following the contents of the received maintenance command, in the registered information or not according to the control program and security program stored in the ROM 105 (S16). When the received IP address is the IP address of the classification in which the maintenance processing can be performed following the contents of the received maintenance command (YES in S16), according to the control program and security program stored in the ROM 105, the control part 101 performs the maintenance processing following the contents of the received maintenance command of the image processing device 1 (S17), and the process is ended. When the received IP address is not the IP address of the classification in which the maintenance processing can be performed following the contents of the received maintenance command (NO in S16), according to the control program and security program stored in the ROM 105, the control part 101 prohibits the processing following the contents of the received maintenance command (S18). Then, the control part 101 notifies the external device that the processing cannot be performed by transmitting the information indicating prohibition of the processing to the source external device of the received information (S19), and the process is ended.

As described above in detail, the image processing device 1 of the present invention determines where the processing according to the information received from the external device can be performed or not based on the IP address received from the external device. Specifically, the communication path of the external device is examined from the network address, and the processing following the processing command of image data received from the external device is prohibited when the information source external device is the external device connected to the communication network further outside the communication network N1 connected to the image processing device 1. Therefore, taking out the image data by accessing to the image processing device 1 from the outside of the range of the limited communication network such as intra-firm LAN is prevented. Accordingly, the image data can be protected against the unauthorized use, and the information security of the image processing device 1 can be improved.

Similarly the processing following the contents of the maintenance command of the image processing device received from the external device connected to the communication network N3 further outside the communication network N1 connected to the image processing device 1 is prohibited in the present invention. By this, that the image processing device 1 cannot protect the image data against the unauthorized use by illegally controlling the state of the image processing device 1 such that the setting of the image processing device 1 is changed to be able to transmit the information to the outside of the communication network N1 is prevented. Accordingly, the information security of the image processing device 1 can further be improved. Further, in the present invention, the identification information of the external device is stored while classified in the contents of the maintenance command in which the processing can be performed, and thereby the processing following the received maintenance command is permitted only when the source external device of the maintenance command is classified in the external device in which the processing following the contents of the maintenance command can be performed. By this, the external device which can transmit the maintenance command to the image processing device 1 to adjust the image processing device 1 is limited to the external device such as an administrator's PC, so that the unauthorized control of the image processing device 1 becomes more difficult, and the information security of the image processing device 1 is improved.

Although the method of determining whether the processing can be performed or not for the information received by the communication part 103 is used in the embodiment, the method of determining whether the processing can be performed or not for the information received by the interface except for the communication part 103 may be used such that the processing according to the information received from the modem part 110 is prohibited. For the path information according to the present invention, although the configuration in which the communication path between the image processing device 1 and the external device is checked by using the network address included in the IP address is adopted in the embodiment, the present invention is not limited to the configuration of the embodiment. For example, the communication path may be checked by receiving the information on a router or a server, through which the information is transmitted from the external device, to utilize the information on the router or server.

For the processing command of the image data received within the predetermined path range, although the processing following all the contents of the processing command is performed in the embodiment, the present invention is not limited to the embodiment. For the contents of the processing command of the image data such as the command outputting the image data transmitted from the external device as the image and the command transmitting the image data stored in the storing part 106 to the external device, the processing following the received processing command may be permitted by classifying the external device with respect to the contents, which can be processed, to store the IP address in the management part 104, only when the source external device of the image data processing command is classified in the external device in which the processing following the contents of the processing command can be performed.

Moreover, in the embodiment, the image processing device 1 of the present invention is described as the network printer device connected to the communication network N1. However, the image processing device 1 of the present invention may be an image data server device, connected to the communication network N1, in which the image data is stored.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image processing device comprising: receiving means for receiving information from an external device; and means for performing processing of an image data according to the received information, characterized by comprising:
protecting means capable of switching a state thereof between a state in which operation for protecting the image data can be performed and a state in which said operation cannot be performed; and
restricting means for restricting said processing when said protecting means is in the state in which said operation can be performed.

2. An image processing device comprising: receiving means for receiving information from an external device; and means for performing processing of an image data according to the received information, characterized by comprising:
means for detachably mounting protecting means which can, when mounted, perform an operation for protecting the image data; and
restricting means for restricting said processing when said operation of said protecting means can be performed.

3. An image processing device as set forth in claim 1 or 2, characterized in that
said receiving means comprises:
means for receiving path information indicating communication path of said external device from said external device; and
means for receiving a processing command of the image data from the external device, and
said restricting means comprises:
means for determining whether said communication path falls within a predetermined path range or not based on the path information received by said receiving means;
means for permitting a processing following said processing command when said communication path falls within the predetermined path range; and
means for prohibiting a processing following said processing command when said communication path does not fall within the predetermined path range.

4. The image processing device as set forth in any one of claims 1 through 3, characterized by further comprising means for performing a processing for maintenance according to the information received from the external device, wherein
said receiving means comprises:
means for receiving the path information indicating the communication path of said external device from the external device; and
means for receiving a maintenance command instructing said processing from the external device, and
said restricting means comprises:
means for determining whether said communication path falls within the predetermined path range or not based on the path information received by said receiving means; and
means for prohibiting said processing when said communication path does not fall within the predetermined path range.

5. The image processing device as set forth in claim 4, characterized in that
said receiving means further comprises means for receiving identification information identifying the external device,
storing means is provided, said storing means storing the identification information of the external device previously determined as a source external device of the maintenance command, while the maintenance command received from the external device are classified by contents of the maintenance command capable of performing processing, and
said restricting means comprises:
means for determining whether the identification information received by said receiving means coincides with any of the identification information stored in said storing means, when said communication path falls within the predetermined path range;
means for prohibiting a processing following the maintenance command received by said receiving means, when the identification information does not coincide;
means for determining whether the identification information is classified so as to be capable of performing a processing following the contents of the maintenance command received by said receiving means or not, when the identification information coincides;
means for permitting said processing, when the identification information is classified so as to be capable of performing said processing; and
means for prohibiting said processing, when the identification information is not classified so as to be capable of performing said processing.

6. An image processing device comprising:
receiving means for receiving information from an external device;
image data processing means for performing processing of an image data according to the received information;
protecting means capable of switching own state between a state in which operation for protecting the image data can be performed and a state in which said operation cannot be performed; and
restricting means for restricting processing of the image data according to the received information performed by said image data processing means, when said protecting means is switched to the state in which the operation for protecting image data can be performed.

7. The image processing device as set forth in claim 6, wherein said receiving means comprises:
path information receiving means for receiving, from the external device, path information indicating communication path of said external device; and
processing command receiving means for receiving, from the external device, processing command information instructing processing of the image data, and
said restricting means comprises:
determining means for determining whether a source external device of the processing command information received by said processing command receiving means is the external device within a predetermined communication path or not based on the path information received by said path information receiving means;
means for permitting said image data processing means to perform the processing following the processing command information received by said processing command receiving means, when said determining means determines that the source external device of the processing command information is the external device within the predetermined communication path; and
means for not permitting said image data processing means to perform the processing following the processing command information received by said processing command receiving means, when said determining means determines that the source external device of the processing command information is not the external device within the predetermined communication path.

8. The image processing device as set forth in claim 7, further comprising maintenance processing means for performing a maintenance processing of a plurality of different contents for maintaining itself according to given information, wherein
said receiving means further comprises maintenance command receiving means for receiving, from the external device, maintenance command information instructing the contents of the maintenance processing to give the maintenance command information to said maintenance processing means; and
said restricting means further comprises means for prohibiting said maintenance processing means to perform the maintenance processing, when said determining means determines that the source external device of the processing command information is not the external device within a predetermined communication path.

9. The image processing device as set forth in claim 8, further comprising storing means for storing classification information in which identification information for identifying the external device is classified according to contents of the executable maintenance processing when the maintenance command information is received from each external device, wherein
said receiving means further comprises identification information receiving means for receiving the identification information of the source external device of the maintenance command information received by said maintenance command receiving means, and
said restricting means further comprises:
identification information determining means for determining whether the identification information received by said identification information receiving means coincides with any of the identification information stored in said storing means, when said determining means determines that the source external device of the maintenance command information received by said maintenance command receiving means is the external device within the predetermined communication path;
means for prohibiting said maintenance processing means to perform the maintenance processing, when the coincidence is not obtained in the determination result by said identification information determining means;
classification determining means for determining whether the contents of the maintenance command, according to the classification information stored in said storing means, of the identification information received by said identification information receiving means coincides with the contents of the maintenance command information received by said maintenance command receiving means or not, when the coincidence is obtained in the determination result by said identification information determining means;
means for permitting said maintenance processing means to perform the maintenance processing following the contents of the maintenance command information received by said maintenance command receiving means, when the coincidence is obtained in the determination result by said classification determining means; and
means for prohibiting said maintenance processing means to perform the maintenance processing, when the coincidence is not obtained in the determination result by said classification determining means.

10. The image processing device as set forth in claim 6, further comprising maintenance processing means for performing a maintenance processing of a plurality of different contents for maintaining itself according to given information, wherein
said receiving means further comprises:
path information receiving means for receiving, from the external device, path information indicating communication path of said external device; and
maintenance command receiving means for receiving, from the external device, maintenance command information instructing the contents of the maintenance processing to give the maintenance command information to said maintenance processing means, and
said restricting means further comprises:
determining means for determining whether a source external device of the maintenance command information received by said maintenance command receiving means is the external device within a predetermined communication path or not based on the path information received by said path information receiving means; and
means for prohibiting said maintenance processing means to perform the maintenance processing, when said determining means determines that the source external device of said maintenance command information is not the external device within the predetermined communication path.

11. The image processing device as set forth in claim 10, further comprising storing means for storing classification information in which identification information for identifying the external device is classified according to contents of the executable maintenance processing when the maintenance command information is received from each external device, wherein
said receiving means further comprises identification information receiving means for receiving the identification information of the source external device of the maintenance command information received by said maintenance command receiving means, and
said restricting means further comprises:
identification information determining means for determining whether the identification information received by said identification information receiving means coincides with any of the identification information stored in said storing means, when said determining means determines that the source external device of the maintenance command information received by said maintenance command receiving means is the external device within the predetermined communication path;
means for prohibiting said maintenance processing means to perform the maintenance processing, when the coincidence is not obtained in the determination result by said identification information determining means;
classification determining means for determining whether the contents of the maintenance command, according to the classification information stored in said storing means, of the identification information received by said identification information receiving means coincides with the contents of the maintenance command information received by said maintenance command receiving means or not, when the coincidence is obtained in the determination result by said identification information determining means;
means for permitting said maintenance processing means to perform the maintenance processing following the contents of the maintenance command information received by said maintenance command receiving means, when the coincidence is obtained in the determination result by said classification determining means; and
means for prohibiting said maintenance processing means to perform the maintenance processing, when the coincidence is not obtained in the determination result by said classification determining means.

12. An image processing device comprising:
receiving means for receiving information from an external device;
image data processing means for performing processing of an image data according to the received information;
protecting means, which is detachably mounted, for performing operation for protecting the image data, when mounted; and
restricting means for restricting processing of the image data according to the received information performed by said image data processing means, when said protecting means is mounted.

13. The image processing device as set forth in claim 12, wherein
said receiving means comprises:
path information receiving means for receiving, from the external device, path information indicating communication path of said external device; and
processing command receiving means for receiving, from the external device, processing command information instructing processing of the image data, and
said restricting means comprises:
determining means for determining whether a source external device of the processing command information received by said processing command receiving means is the external device within a predetermined communication path or not based on the path information received by said path information receiving means;
means for permitting said image data processing means to perform the processing following the processing command information received by said processing command receiving means, when said determining means determines that the source external device of the processing command information is the external device within the predetermined communication path; and
means for not permitting said image data processing means to perform the processing following the processing command information received by said processing command receiving means, when said determining means determines that the source external device of the processing command information is not the external device within the predetermined communication path.

14. The image processing device as set forth in claim 13, further comprising maintenance processing means for performing a maintenance processing of a plurality of different contents for maintaining itself according to given information, wherein
said receiving means further comprises maintenance command receiving means for receiving, from the external device, maintenance command information instructing the contents of the maintenance processing to give the maintenance command information to said maintenance processing means; and
said restricting means further comprises means for prohibiting said maintenance processing means to perform the maintenance processing, when said determining means determines that the source external device of the processing command information is not the external device within a predetermined communication path.

15. The image processing device as set forth in claim 14, further comprising storing means for storing classification information in which identification information for identifying the external device is classified according to contents of the executable maintenance processing when the maintenance command information is received from each external device, wherein
said receiving means further comprises identification information receiving means for receiving the identification information of the source external device of the maintenance command information received by said maintenance command receiving means, and
said restricting means further comprises:
identification information determining means for determining whether the identification information received by said identification information receiving means coincides with any of the identification information stored in said storing means, when said determining means determines that the source external device of the maintenance command information received by said maintenance command receiving means is the external device within the predetermined communication path;
means for prohibiting said maintenance processing means to perform the maintenance processing, when the coincidence is not obtained in the determination result by said identification information determining means;
classification determining means for determining whether the contents of the maintenance command, according to the classification information stored in said storing means, of the identification information received by said identification information receiving means coincides with the contents of the maintenance command information received by said maintenance command receiving means or not, when the coincidence is obtained in the determination result by said identification information determining means;
means for permitting said maintenance processing means to perform the maintenance processing following the contents of the maintenance command information received by said maintenance command receiving means, when the coincidence is obtained in the determination result by said classification determining means; and
means for prohibiting said maintenance processing means to perform the maintenance processing, when the coincidence is not obtained in the determination result by said classification determining means.

16. The image processing device as set forth in claim 12, further comprising maintenance processing means for performing a maintenance processing of a plurality of different contents for maintaining itself according to given information, wherein
said receiving means further comprises:
path information receiving means for receiving, from the external device, path information indicating communication path of said external device; and
maintenance command receiving means for receiving, from the external device, maintenance command information instructing the contents of the maintenance processing to give the maintenance command information to said maintenance processing means, and
said restricting means further comprises:
determining means for determining whether a source external device of the maintenance command information received by said maintenance command receiving means is the external device within a predetermined communication path or not based on the path information received by said path information receiving means; and
means for prohibiting said maintenance processing means to perform the maintenance processing, when said determining means determines that the source external device of said maintenance command information is not the external device within the predetermined communication path.

17. The image processing device as set forth in claim 16, further comprising storing means for storing classification information in which identification information for identifying the external device is classified according to contents of the executable maintenance processing when the maintenance command information is received from each external device, wherein
said receiving means further comprises identification information receiving means for receiving the identification information of the source external device of the maintenance command information received by said maintenance command receiving means, and
said restricting means further comprises:
identification information determining means for determining whether the identification information received by said identification information receiving means coincides with any of the identification information stored in said storing means, when said determining means determines that the source external device of the maintenance command information received by said maintenance command receiving means is the external device within the predetermined communication path;
means for prohibiting said maintenance processing means to perform the maintenance processing, when the coincidence is not obtained in the determination result by said identification information determining means;
classification determining means for determining whether the contents of the maintenance command, according to the classification information stored in said storing means, of the identification information received by said identification information receiving means coincides with the contents of the maintenance command information received by said maintenance command receiving means or not, when the coincidence is obtained in the determination result by said identification information determining means;
means for permitting said maintenance processing means to perform the maintenance processing following the contents of the maintenance command information received by said maintenance command receiving means, when the coincidence is obtained in the determination result by said classification determining means; and
means for prohibiting said maintenance processing means to perform the maintenance processing, when the coincidence is not obtained in the determination result by said classification determining means.

18. An image processing device comprising: a receiving part for receiving information from an external device; a security program storing part for storing security program capable of switching own state between a state in which operation for protecting the image data can be performed and a state in which said operation cannot be performed; and a processor connected with said receiving part and said security program storing part,
wherein said processor capable of performing the following operations:
processing the image data according to the information received by said receiving part; and
according to said security program, restricting processing of the image data according to the received information, when said security program is switched to the state in which the operation for protecting the image data can be performed.

19. The image processing device as set forth in claim 18, wherein said processor further capable of performing the following operations:
by said receiving part, receiving, from the external device, path information indicating communication path of said external device; and
by said receiving part, receiving, from the external device, processing command information instructing processing of the image data;
determining whether a source external device of the processing command information received by said receiving part is the external device within a predetermined communication path or not based on the path information received by said receiving part;
performing the processing following the processing command information received by said receiving part, when the source external device of the processing command information is the external device within the predetermined communication path; and
not performing the processing following the processing command information received by said receiving part, when the source external device of the processing command information is not the external device within the predetermined communication path.

20. The image processing device as set forth in claim 19, wherein said processor further capable of performing the following operations:
performing a maintenance processing of a plurality of different contents for maintaining said image processing device according to given information;
by said receiving part, receiving, from the external device, maintenance command information instructing the contents of the maintenance processing; and
not performing the maintenance processing, when the source external device of the maintenance command information received by said receiving part is not the external device within the predetermined communication path.

21. The image processing device as set forth in claim 20, further comprising a classification information storing part connected with said processor and storing classification information in which identification information for identifying the external device is classified according to contents of the executable maintenance processing when the maintenance command information is received from each external device,
wherein said processor further capable of performing the following operations:
by said receiving part, receiving the identification information of the source external device of the received maintenance command information;
determining whether the identification information received by said receiving part coincides with any of the identification information stored in said classification information storing part, when the source external device of the maintenance command information received by said receiving part is the external device within the predetermined communication path;
not performing the maintenance processing, when the coincidence is not obtained in the determination result;
determining whether the contents of the maintenance command, according to the classification information stored in said classification information storing part, of the identification information received by said receiving part coincides with the contents of the maintenance command information received by said receiving part or not, when the coincidence is obtained in the determination result;
performing the maintenance processing following the contents of the maintenance command information received by said receiving part, when the coincidence is obtained in the determination result; and
not performing the maintenance processing, when the coincidence is not obtained in the determination result.

22. The image processing device as set forth in claim 18, wherein said processor further capable of performing the following operations:
performing a maintenance processing of a plurality of different contents for maintaining said image processing device according to given information;
by said receiving part, receiving, from the external device, path information indicating communication path of said external device;
by said receiving part, receiving, from the external device, maintenance command information instructing the contents of the maintenance processing;
determining whether a source external device of the maintenance command information received by said receiving part is the external device within a predetermined communication path or not based on the path information received by said receiving part; and
not performing the maintenance processing, when the source external device of said maintenance command information is not the external device within the predetermined communication path.

23. The image processing device as set forth in claim 22, further comprising a classification information storing part connected with said processor and storing classification information in which identification information for identifying the external device is classified according to contents of the executable maintenance processing when the maintenance command information is received from each external device,
wherein said processor further capable of performing the following operations:
by said receiving part, receiving the identification information of the source external device of the received maintenance command information;
determining whether the identification information received by said receiving part coincides with any of the identification information stored in said classification information storing part, when the source external device of the maintenance command information received by said receiving part is the external device within the predetermined communication path;
not performing the maintenance processing, when the coincidence is not obtained in the determination result;
determining whether the contents of the maintenance command, according to the classification information stored in said classification information storing part, of the identification information received by said receiving part coincides with the contents of the maintenance command information received by said receiving part or not, when the coincidence is obtained in the determination result;
performing the maintenance processing following the contents of the maintenance command information received by said receiving part, when the coincidence is obtained in the determination result; and
not performing the maintenance processing, when the coincidence is not obtained in the determination result.

24. An image processing device comprising: receiving part for receiving information from an external device; a security program storing part, detachably mounted, and storing security program which, when mounted, performs operation for protecting the image data; and a processor connected with said receiving part and said security program storing part when mounted,
wherein said processor capable of performing the following operations:
processing the image data according to the information received by said receiving part; and
according to said security program, restricting processing of the image data according to the received information, when said security program storing part is mounted.

25. The image processing device as set forth in claim 24, wherein said processor further capable of performing the following operations:
by said receiving part, receiving, from the external device, path information indicating communication path of said external device; and
by said receiving part, receiving, from the external device, processing command information instructing processing of the image data;
determining whether a source external device of the processing command information received by said receiving part is the external device within a predetermined communication path or not based on the path information received by said receiving part;
performing the processing following the processing command information received by said receiving part, when the source external device of the processing command information is the external device within the predetermined communication path; and
not performing the processing following the processing command information received by said receiving part, when the source external device of the processing command information is not the external device within the predetermined communication path.

26. The image processing device as set forth in claim 25, wherein said processor further capable of performing the following operations:
performing a maintenance processing of a plurality of different contents for maintaining said image processing device according to given information;
by said receiving part, receiving, from the external device, maintenance command information instructing the contents of the maintenance processing; and
not performing the maintenance processing, when the source external device of the maintenance command information received by said receiving part is not the external device within the predetermined communication path.

27. The image processing device as set forth in claim 26, further comprising a classification information storing part connected with said processor and storing classification information in which identification information for identifying the external device is classified according to contents of the executable maintenance processing when the maintenance command information is received from each external device,
wherein said processor further capable of performing the following operations:
by said receiving part, receiving the identification information of the source external device of the received maintenance command information;
determining whether the identification information received by said receiving part coincides with any of the identification information stored in said classification information storing part, when the source external device of the maintenance command information received by said receiving part is the external device within the predetermined communication path;
not performing the maintenance processing, when the coincidence is not obtained in the determination result;
determining whether the contents of the maintenance command, according to the classification information stored in said classification information storing part, of the identification information received by said receiving part coincides with the contents of the maintenance command information received by said receiving part or not, when the coincidence is obtained in the determination result;
performing the maintenance processing following the contents of the maintenance command information received by said receiving part, when the coincidence is obtained in the determination result; and
not performing the maintenance processing, when the coincidence is not obtained in the determination result.

28. The image processing device as set forth in claim 24, wherein said processor further capable of performing the following operations:
performing a maintenance processing of a plurality of different contents for maintaining said image processing device according to given information;
by said receiving part, receiving, from the external device, path information indicating communication path of said external device;
by said receiving part, receiving, from the external device, maintenance command information instructing the contents of the maintenance processing;
determining whether a source external device of the maintenance command information received by said receiving part is the external device within a predetermined communication path or not based on the path information received by said receiving part; and
not performing the maintenance processing, when the source external device of said maintenance command information is not the external device within the predetermined communication path.

29. The image processing device as set forth in claim 28, further comprising a classification information storing part connected with said processor and storing classification information in which identification information for identifying the external device is classified according to contents of the executable maintenance processing when the maintenance command information is received from each external device,
wherein said processor further capable of performing the following operations:
by said receiving part, receiving the identification information of the source external device of the received maintenance command information;
determining whether the identification information received by said receiving part coincides with any of the identification information stored in said classification information storing part, when the source external device of the maintenance command information received by said receiving part is the external device within the predetermined communication path;
not performing the maintenance processing, when the coincidence is not obtained in the determination result;
determining whether the contents of the maintenance command, according to the classification information stored in said classification information storing part, of the identification information received by said receiving part coincides with the contents of the maintenance command information received by said receiving part or not, when the coincidence is obtained in the determination result;
performing the maintenance processing following the contents of the maintenance command information received by said receiving part, when the coincidence is obtained in the determination result; and
not performing the maintenance processing, when the coincidence is not obtained in the determination result.
